(19) United States
(12) Patent Application Publication
(10) Pub. No.: US 2011/0149219 A1
(43) Pub. Date: Jun. 23, 2011

(54) LIQUID CRYSTAL DISPLAY DEVICE

(76) Inventors: Hye Rin Hyun, Paju-si (KR); Kyo Seop Choo, Suwon-si (KR); Hyun Jin Kim, Anyang-si (KR)

(21) Appl. No.: 12/816,477

(22) Filed: Jun. 16, 2010

(30) Foreign Application Priority Data
Dec. 21, 2009 (KR) 10-2009-0128202

(51) Int. Cl. G02F 1/1335

(52) U.S. Cl. 349/108; 349/113

(57) ABSTRACT

An LCD device is disclosed, which is capable of displaying a predetermined color by reflecting externally-provided light during a non-driving mode of a liquid crystal panel, the LCD device comprising a lower substrate including a plurality of pixel regions, and a plurality of reflective regions for reflecting incident light provided from the external, wherein the plurality of pixel regions are defined by gate and data lines crossing at right angles to each other, and each reflective region is formed every predetermined number of the pixel regions; an upper substrate including respective red (R), green (G) and blue (B) color filters for transmitting red (R)-colored light, green (G)-colored light and blue (B)-colored light, and a dummy color filter for transmitting a predetermined-colored light, wherein the respective color filters are confronting in position with the plurality of pixel regions, and the dummy color filter is confronting in position with the reflective region; and an external case for covering the lower and upper substrates.

This application claims the benefit of Korea Patent Application No. 10-2009-0128202 filed on Dec. 21, 2009, which is incorporated herein by reference for all purposes as if fully set forth herein.

### BACKGROUND

1. Field of the Invention

The present disclosure relates to a liquid crystal display (LCD) device, and more particularly, to an LCD device which is capable of displaying a predetermined color by reflecting externally-provided light during a non-driving mode of a liquid crystal panel. Although the present invention is suitable for a wide scope of applications, it is particularly suitable for displaying the liquid crystal panel with the same color as that of an external case during the non-driving mode of the liquid crystal panel.

2. Discussion of the Related Art

Generally, an active matrix type LCD device displays images by controlling light transmittance of liquid crystal through a thin film transistor (hereinafter, referred to as “TFT”) serving as a switching element. The LCD device has been widely used in various fields of portable information devices, office devices, computer and IT products, and etc., owing to the advantageous properties of low power consumption, thin profile, and lightness in weight.

The LCD device cannot emit light in itself. That is, it is necessary to additionally provide light to the LCD device. The LCD device can display images through the use of light emitted from a backlight unit positioned under a liquid crystal panel or light provided from the external. When maximizing transmittance of light through a liquid crystal layer of the liquid crystal panel, a white-color image with high luminance can be displayed on the liquid crystal panel. Meanwhile, when minimizing transmittance of light through the liquid crystal layer of the liquid crystal panel, a black-color image with low luminance can be displayed on the liquid crystal panel.

Hereinafter, an LCD device according to the related art will be described in detail with reference to the accompanying drawings.

FIG. 1 is a perspective view illustrating the LCD device according to the related art.

Referring to FIG. 1, the LCD device according to the related art includes a liquid crystal panel 40 provided with a lower substrate 10, an upper substrate 20, and a liquid crystal layer (not shown) formed between the lower and upper substrates 10 and 20; a backlight unit (not shown) for supplying light to the liquid crystal panel 40; a polarizing film (not shown) formed on the upper substrate 20; and a driving circuit (not shown) for driving the liquid crystal panel 40.

On the lower substrate 10 of the liquid crystal panel 40, there are gate and data lines 11 and 12, and a thin film transistor 13. The gate and data lines 11 and 12 cross at right angles to each other, that is, are perpendicular to each other, to thereby define a pixel region. The thin film transistor 13 is formed at a crossing of the gate and data lines 11 and 12, wherein the thin film transistor 13 functions as a switching element. In the pixel region, there is a pixel electrode 14 formed of a transparent conductive material such as ITO (Indium Tin Oxide), wherein the pixel electrode 14 is formed in parallel to the data line 12 and is electrically connected with the thin film transistor 13.

On the upper substrate 20 of the liquid crystal panel 40, there are a light-shielding layer 21, and a color filter layer 22. The light-shielding layer 21 prevents the light from leaking in the gate line 11, the data line 12, and the thin film transistor 13. The color filter layer 22 is interposed in-between each light-shielding layer 21, wherein the color filter layer 22 transmits only light with a predetermined wavelength. In this case, the color filter layer 22 comprises red (R), green (G), and blue (B) color filters.

When the thin film transistor 13 is turned-on by a diving signal applied to the gate line 11, a data signal applied to the data line 12 is applied to the pixel electrode 14 through a channel layer of the thin film transistor 13. Through the aforementioned process, it is possible to control the light transmittance of liquid crystal. Then, the light transmitted through the liquid crystal layer passes through the color filter layer 22, thereby displaying full-color images.

FIG. 2 is a plane view illustrating a mobile LCD terminal 60 (hereinafter, referred to as “terminal”) with LCD device according to the related art.

As shown in FIG. 2, the terminal 60 includes an external case 50, a liquid crystal panel 40, a backlight unit for supplying the light to the liquid crystal panel 40, and a polarizing film (not shown) formed on the liquid crystal panel 40.

As mentioned above, when the terminal 60 according to the related art is in a non-driving mode, that is, power is not applied to the terminal 60 according to the related art the liquid crystal panel 40 does not emit the light. Instead, the externally-provided light is absorbed by the polarizing film, whereby the liquid crystal panel 40 is displayed in a black color.

Recently, the terminal 60 is regarded as an accessory beyond a simple communication means. That is, color and design of the external case 50 in the terminal 60 may be selected as one of the important factors in determining the consumer's preference for the product. In this respect, it is important to realize various colors as well as black or white in the external case 50 of the terminal 60.

However, the terminal 60 according to the related art is formed in such a way that the liquid crystal panel 40 is displayed only in the black color during the non-driving mode. During the non-driving mode, the external case 50 is different from the liquid crystal panel 40 in color, which might cause a decline in consumer's preference.

### BRIEF SUMMARY

An LCD device comprises a lower substrate including a plurality of pixel regions, and a plurality of reflective regions for reflecting incident light provided from the external, wherein the plurality of pixel regions are defined by gate and data lines crossing at right angles to each other, and each reflective region is formed every predetermined number of the pixel regions; an upper substrate including respective red (R), green (G) and blue (B) color filters for transmitting red (R)-colored light, green (G)-colored light and blue (B)-colored light, and a dummy color filter for transmitting a predetermined-colored light, wherein the respective color filters are confronting in position with the plurality of pixel regions, and the dummy color filter is confronting in position with the reflective region; and an external case for covering the lower and upper substrates.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an LCD device according to the related art;

FIG. 2 is a plane view illustrating a mobile LCD terminal with LCD device according to the related art;

FIG. 3 is a cross section view illustrating an LCD device according to an embodiment of the present invention;

FIG. 4 is a plane view illustrating a mobile LCD terminal with LCD device according to an embodiment of the present invention;

FIG. 5 is a cross section view along A-A′ of FIG. 4; and

FIGS. 6 and 7 illustrate a method for driving an LCD device according to an embodiment of the present invention.

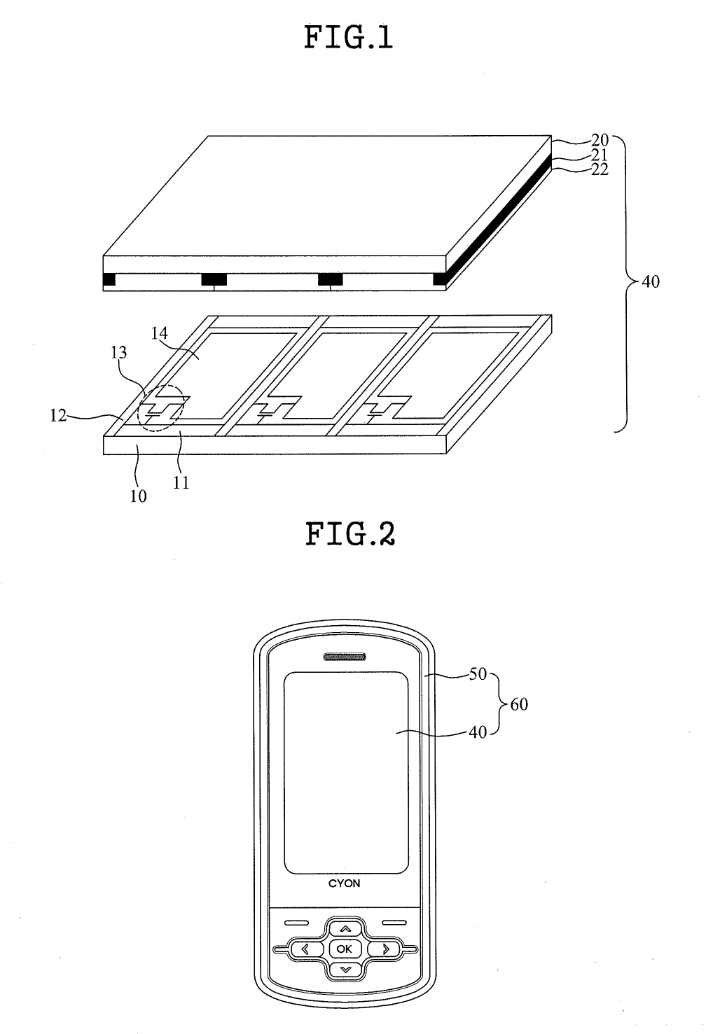

### DETAILED DESCRIPTION OF THE DRAWINGS AND THE PRESENTLY PREFERRED EMBODIMENTS

Reference will now be made in detail to the embodiments of the present invention, examples of which are illustrated in the accompanying drawings. Wherever possible, the same reference numbers will be used throughout the drawings to refer to the same or like parts.

Hereinafter, an LCD device according to the present invention will be described with reference to the accompanying drawings. The LCD device according to the present invention includes a reflective region on a lower substrate, and a dummy color filter on an upper substrate, wherein the dummy color filter on the upper substrate is confronting in position with the reflective region on the lower substrate. At this time, the reflective region reflects incident light provided from the external of a liquid crystal panel, and the dummy color filter transmits light with the same color as that of an external case.

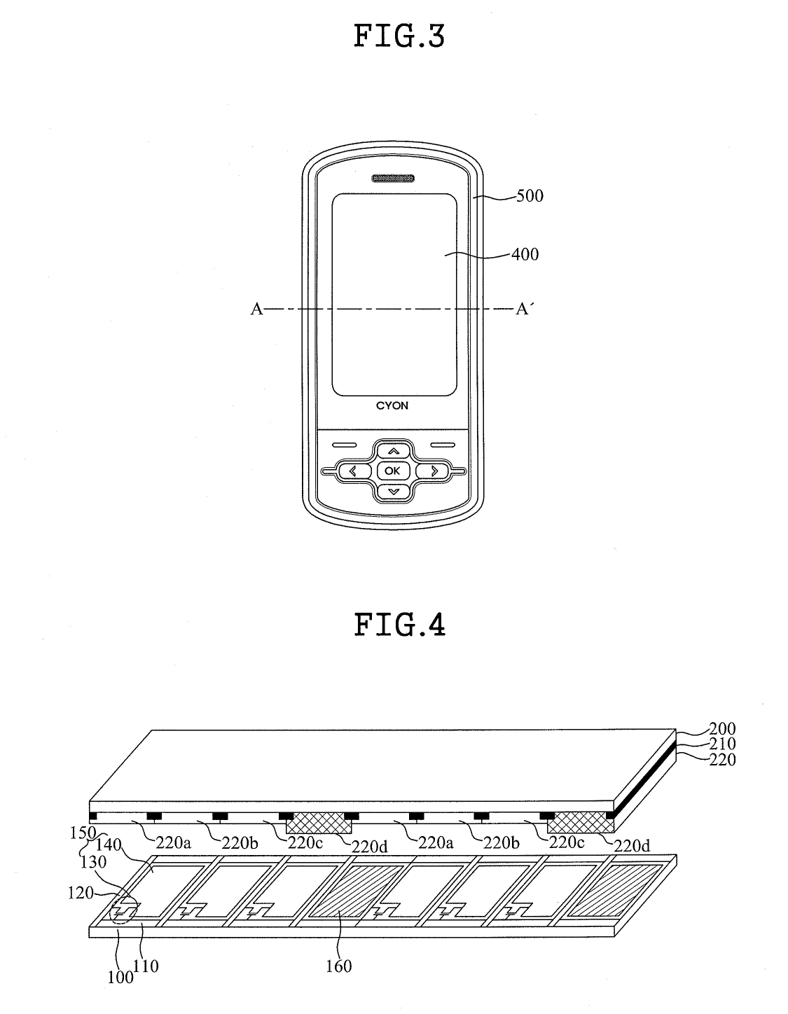

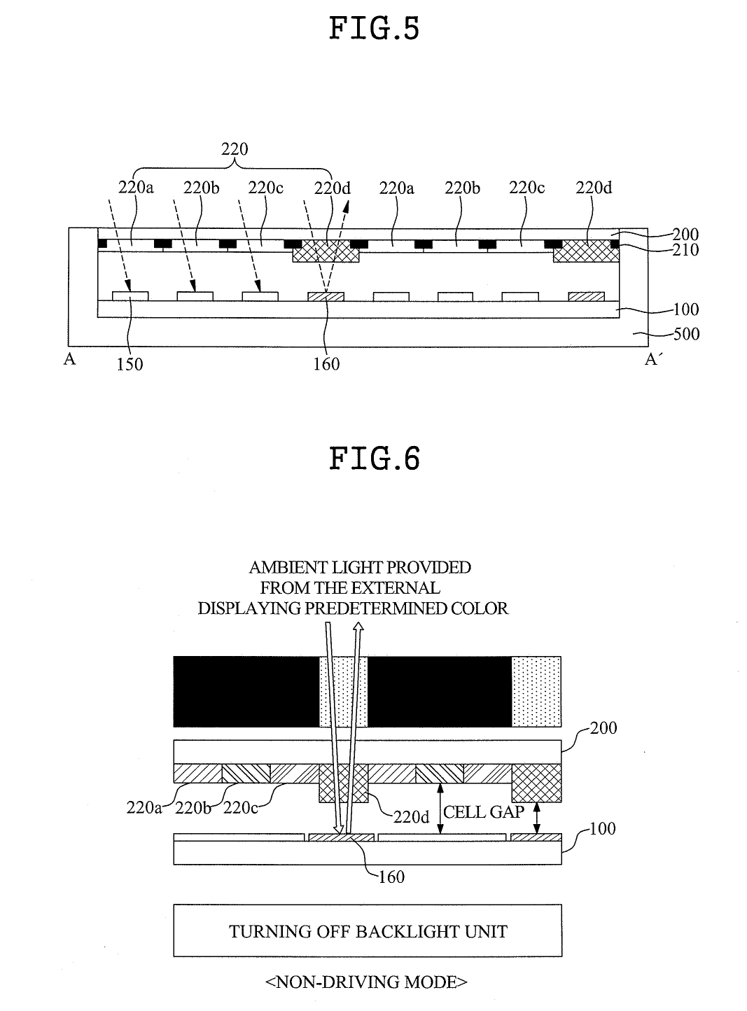

FIG. 3 is a cross section view illustrating an LCD device according to an embodiment of the present invention. FIG. 4 is a plan view illustrating a mobile LCD terminal with LCD device according to an embodiment of the present invention. FIG. 5 is a cross section view along A-A′ of FIG. 4.

Referring to FIGS. 3 to 5, the mobile LCD terminal with LCD device (hereinafter, referred to as “terminal”) according to an embodiment of the present invention includes an LCD device, and an external case 500 for covering the LCD device.

The LCD device includes a liquid crystal panel; a backlight unit (not shown) for supplying light to the liquid crystal panel; a polarizing film (not shown) for polarizing light emitted from the liquid crystal panel and also incident on the liquid crystal panel, the polarizing film (not shown) positioned on the liquid crystal panel; and a driving circuit (not shown) for driving the liquid crystal panel. At this time, the liquid crystal panel includes lower and upper substrates 100 and 200 confronting each other; and a liquid crystal layer (not shown) formed between the lower and upper substrates 100 and 200.

On the lower substrate 100 of the liquid crystal panel, there are gate and data lines 110 and 120. Also, a pixel region 150 and a reflective region 160 are defined by the gate and data lines 110 and 120 crossing at right angles to each other, that is, the gate and data lines 110 and 120 perpendicular to each other.

A thin film transistor 130 and a pixel electrode 140 are formed on the lower substrate 100, wherein the thin film transistor 130 functions as a switching element. In the pixel region 150, there is the pixel electrode 140 formed of a transparent conductive material such as ITO (Indium Tin Oxide), wherein the pixel electrode 140 is formed in parallel to the data line 120 and is electrically connected with the thin film transistor 130.

According as a scan signal is received in the gate line 110 on the lower substrate 100 from a gate driving circuit (not shown), the gate line 110 supplies the received scan signal to the thin film transistor 130. According as an analog data signal is received in the data line 120 on the lower substrate 100 from a data driving circuit (not shown), the data line 120 supplies the received analog data signal to the thin film transistor 130.

In response to the scan signal from the gate line 110, the thin film transistor 130 supplies the analog data signal from the data line 120 to the pixel electrode 140. Thereafter, in response to the analog data signal from the thin film transistor 130, the pixel electrode 140 applies an electric field to the liquid crystal layer.

The upper substrate 200 includes a light-shielding layer 201 and a color filter layer 220. At this time, the light-shielding layer 201 is formed to prevent leakage of the light; and the color filter layer 220 for transmitting only colored light with a predetermined wavelength is interposed between each light-shielding layer 210.

The light-shielding layer 210 is formed of a black matrix (BM). The color filter layer 220 comprises color filters 220a for transmitting red (R)-colored light (hereinafter, referred to as “red (R) color filters 220a”); color filters 220b for transmitting green (G)-colored light (hereinafter, referred to as “green (G) color filters 220b”); color filters 220c for transmitting blue (B)-colored light (hereinafter, referred to as “blue (B) color filters 220c”); and dummy color filters 220d for transmitting predetermined colored light. At this time, each reflective region 160 on the lower substrate 100 is confronting in position with each dummy color filter 220d on the upper substrate 200.

The reflective region 160 may be formed of a material enabling to reflect the externally-provided light. For example, the reflective region 160 may be formed of a light-reflecting material such as magnesium oxide (MgO), luminescent pigment, fluorescent pigment, argentums (Ar), aurum (Au) or aluminum (Al); or a predetermined material mixed with at least one of the aforementioned light-reflecting materials. At this time, the reflective region 160 may have a flat surface, as shown in FIG. 4. In another embodiment of the present invention, the reflective region 160 may have an embossed surface so as to enhance light-reflecting efficiency.

If each unit pixel may comprise the three pixel electrodes 140, the reflective region 160 may be provided every three pixel electrodes 140. However, it is unnecessary to provide one reflective region 160 every three pixel electrodes 140. The number of reflective regions 160 may vary according to the desired luminance in the liquid crystal panel 400.

The reflective region 160 is formed of the material enabling to reflect the externally-provided light. That is, the reflective region 160 excludes the light emitted from the backlight unit, wherein the backlight unit is positioned under the liquid crystal panel. Thus, even though it is allowed to form the thin film transistor 130 in the reflective region 160, forming the reflective region 160 without the thin film transistor 130 therein is preferable to forming the reflective region 160 with the thin film transistor 130 therein, to thereby improve the light-reflecting efficiency by enlarging an effective light-reflecting area in the reflective region 160.

The light-shielding layer 210 is formed on the upper substrate 200, wherein the light-shielding layer 210 is formed of a light-impenetrable material so as to prevent the light from leaking in the gate line 110, the data line 120, and the thin film transistor 130.

The color filter layer 220 comprises the red (R) color filters 220a; the green (G) color filters 220b; the blue (B) color filters 220c; and the dummy color filters 220d for transmitting the predetermined colored light. At this time, the red (R), green (G), and blue (B) color filters 220a, 220b, and 220c are confronting in position with the pixel electrodes 140 of the respective pixel regions 150; and the dummy color filters 220d are confronting in position with the reflective regions 160.

The respective red (R), green (G), and blue (B) color filters 220a, 220b, and 220c and dummy color filters 220d are interposed between each light-shielding layer 210. At this time, each of the respective red (R), green (G), and blue (B) color filters 220a, 220b, and 220c and dummy color filters 220d is formed of the material for transmitting the predetermined wavelength, that is, the predetermined colored-light.

The dummy color filters 220d, which are confronting in position with the reflective regions 160, may be formed as the predetermined color so that the liquid crystal panel is displayed in the predetermined color during its non-driving mode. And more preferably, the dummy color filters 220d may be displayed in the same color as that of the external case 500.

In the aforementioned color filter layer 200, the dummy color filters 220d confronting in position with the reflective regions 160 are relatively thicker than the color filters 220a, 220b, and 220c confronting in position with the pixel regions 150.

The reflective regions 160 reflect the externally-provided light during the non-driving mode of the liquid crystal panel, whereby the predetermined color is displayed on the liquid crystal panel through the dummy color filters 220d with the predetermined color.

During a driving mode for displaying an image on the liquid crystal panel 400 through the use of light emitted from the backlight unit, it should be prevented that the light emitted from the backlight unit passes through the reflective regions 160.

For this, each of the dummy color filters 220d should be thicker than each of the respective red (R), green (G), and blue (B) color filters 220a, 220b, and 220c. Thus, a cell gap between the reflective region 160 and the dummy color filter 220d is smaller than a cell gap between the pixel electrode 140 and each of the respective red (R), green (G), and blue (B) color filters 220a, 220b, and 220c, whereby the light is not transmitted through the dummy color filter 220d confronting in position with the reflective region 160 when driving the liquid crystal panel 400.

For example, when driving the liquid crystal panel 400, the pixel electrodes 140 and the red (R), green (G), and blue (B) color filters 220a, 220b, and 220c are arranged in such a way that ½λ dielectric anisotropy is secured in liquid crystal of the cell gap between the pixel electrode 140 and each of the respective red (R), green (G), and blue (B) color filters 220a, 220b, and 220c, whereby the light is transmitted therethrough. In the meantime, when driving the liquid crystal panel 400, the reflective region 160 and the dummy color filters 220d are arranged in such a way that ¼λ dielectric anisotropy is secured in liquid crystal of the cell gap between the reflective region 160 and each of the dummy color filters 220d, whereby the light is not transmitted therethrough. Thus, when driving the liquid crystal panel 400, the light is transmitted in the pixel electrode 140, whereby the full-color image is displayed through the red (R), green (G), and blue (B) color filters 220a, 220b, and 220c. Also, since the ¼λ dielectric anisotropy is secured in liquid crystal of the cell gap between the reflective region 160 and each of the dummy color filters 220d during the driving mode of the liquid crystal panel 400, the light is not transmitted therethrough.

Even though the cell gap between the reflective region 160 and the dummy color filter 220d is relatively smaller than the cell gap between the pixel electrode 140 and each of the respective red (R), green (G), and blue (B) color filters 220a, 220b, and 220c, it makes no influence on driving of the pixel region 150.

As mentioned above, the dummy color filter 220d confronting in position with the reflective region 160 is formed of the material which can transmit the light with the same color as that of the external case 500. During the non-driving mode of the liquid crystal panel 400, the dummy color filter 220d can be displayed in the same color as that of the external case 500.

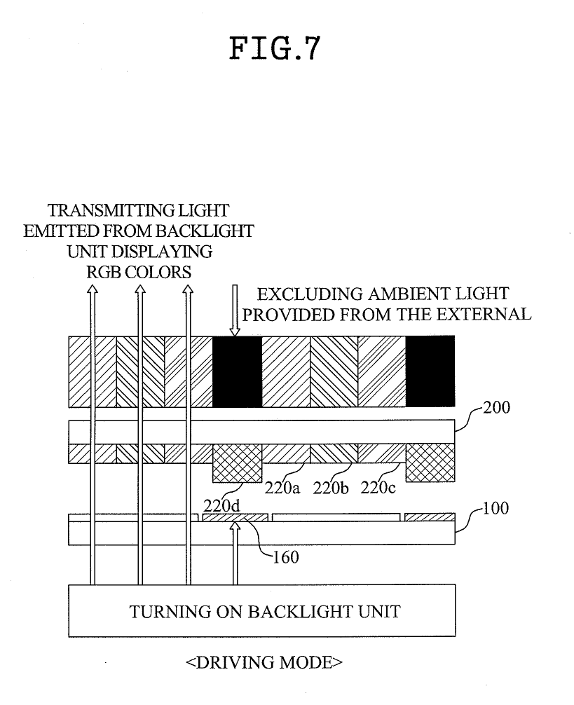

Referring to FIGS. 6 and 7, during the non-driving mode of the liquid crystal panel 400, the backlight unit is turned-off, that is, the light is not supplied to the liquid crystal panel 400, whereby the light is not transmitted through the red (R), green (G), and blue (B) color filters 220a, 220b, and 220c. Thus, a predetermined region corresponding to the pixel region 150 in a display area of the liquid crystal panel 400 is displayed in a black color.

When the externally-provided light is incident on the reflective region 160, the incident light is reflected on the reflective region 160 confronting in position with the dummy color filter 220d, wherein the dummy color filter 220d is formed of the material which can transmit the light with the same color as that of the external case 500. Then, the light reflected on the reflective region 160 is transmitted through the dummy color filter 220d to the external of the liquid crystal panel 400. Through the use of reflective region 160 and dummy color filter 220d, the liquid crystal panel 400 can be displayed in the same color as that of the external case 500 without additional power consumption.

The reflective region 160 is provided every unit pixel comprising the red (R), green (G), and blue (B) pixel regions. Thus, a user recognizes the entire display area of the liquid crystal panel 400 as being displayed in the same color as that of the external case 500. As a result, the LCD device according to the embodiment of the present invention can realize that the color displayed on the liquid crystal panel 400 is the same as the color of the external case 500 during the non-driving mode of the liquid crystal panel 400.

During the driving mode of the liquid crystal panel 400, the backlight unit is turned-on, that is, the light is supplied to the liquid crystal panel 400, to thereby emit the colored light passing through the red (R), green (G), and blue (B) color filters 220a, 220b, and 220c of the pixel regions 150. Thus, the predetermined region confronting in position with the pixel region 150 in the display area of the liquid crystal panel 400 can be displayed in the full-color image.

When the externally-provided light is incident on the predetermined region confronting in position with the reflective region 160, the incident light is absorbed by the polarizing film. Also, as mentioned above, the liquid crystal layer between the reflective region 160 and the dummy color filter 220d has the ¼λ dielectric anisotropy, whereby the liquid crystal layer excludes the light emitted from the backlight unit. That is, during the driving mode of the liquid crystal panel, the light is not transmitted through the predetermined region confronting in position with the reflective region 160. As a result, the predetermined region confronting in position with the reflective region 160 is displayed in the black color, and the predetermined region confronting in position with the pixel region 150 is displayed in the full-color image.

Accordingly, the LCD device according to the present invention is formed in such a way that the liquid crystal panel 400 is capable of being displayed in any other color instead of the black color during the non-driving mode.

During the non-driving mode of the LCD device according to the present invention, the liquid crystal panel 400 can be displayed in the same color as that of the external case 500. Thus, the LCD device with the external case 500 according to the present invention can be recognized as one color during the non-driving mode of the LCD device according to the present invention.

According as the LCD device according to the present invention is formed in such a way that the liquid crystal panel 400 is displayed in the same color as that of the external case 500 during the non-driving mode, esthetic needs can be satisfied by providing the colorful LCD device, to thereby fulfill the consumer's preference for the terminal with the LCD device according to the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An LCD device comprising:
a lower substrate including a plurality of pixel regions, and a plurality of reflective regions that reflect incident light provided from the external, wherein the plurality of pixel regions are defined by gate and data lines crossing at right angles to each other, and each reflective region is formed every predetermined number of the pixel regions;
an upper substrate including respective red (R), green (G) and blue (B) color filters for transmitting red (R)-colored light, green (G)-colored light and blue (B)-colored light, and a dummy color filter that transmits a predetermined-colored light, wherein the respective color filters are confronting in position with the plurality of pixel regions, and the dummy color filter is confronting in position with the reflective region; and
an external case that covers the lower and upper substrates.

2. The LCD device according to claim 1, wherein the dummy color filter is formed of a material which is capable of transmitting light with the same color as that of the external case.

3. The LCD device according to claim 1, further comprising a polarizing film on the upper substrate, the polarizing film for polarizing light transmitted through the upper substrate and the incident light provided from the external.

4. The LCD device according to claim 1, wherein the reflective region is formed of at least one light-reflecting material of magnesium oxide (MgO), luminescent pigment, fluorescent pigment, argentums (Ar), aurum (Au) or aluminum (Al); or the reflective region is formed of a predetermined material mixed with at least one of the aforementioned light-reflecting materials.

5. The LCD device according to claim 1, wherein the reflective region has a flat surface.

6. The LCD device according to claim 1, wherein the reflective region has an embossed surface.

7. The LCD device according to claim 1, wherein the dummy color filter confronting in position with the reflective region is thicker than the color filter confronting in position with the pixel region.

8. The LCD device according to claim 1, wherein a first cell in the reflective region is different from a second cell gal in the pixel region.

9. The LCD device according to claim 8, wherein the first cell gap is smaller than the second cell gap.

10. The LCD device according to claim 8, wherein, when driving the LCD device,
liquid crystal provided between the pixel region and each of the red (R), green (G) and blue (B) color filters has ½λ dielectric anisotropy so as to transmit the light therethrough; and
liquid crystal provided between the reflective region and the dummy color filter has ¼λ dielectric anisotropy so as to prevent the light from being transmitted therethrough.
